(19) United States
(12) Patent Application Publication
(10) Pub. No.: US 2025/0091372 A1
(43) Pub. Date: Mar. 20, 2025

(54) MEDIUM PROCESSING DEVICE

(71) Applicant: SEIKO EPSON CORPORATION, Tokyo (JP)

(72) Inventor: Yoshinori YANAGISAWA, SHIOJIRI-SHI (JP)

(21) Appl. No.: 18/886,215

(22) Filed: Sep. 16, 2024

(30) Foreign Application Priority Data
Sep. 19, 2023 (JP) 2023-150908

(51) Int. Cl. B41J 29/00; B41J 2/155

(52) U.S. Cl. CPC B41J 29/00; B41J 2/155

(57) ABSTRACT

A medium processing device including a housing, a plurality of feet, and capable of coming into contact with an installation surface, and a medium processing unit, wherein the plurality of feet include a first foot, a second foot aligned with the first foot in a width direction of the medium processing device, a third foot aligned with the first foot in a depth direction of the medium processing device, and a fourth foot aligned with the second foot in the depth direction, and when a center of gravity of the medium processing device is located in a fifth region and the medium processing device is provided across a second region and a fourth region, lengths of the first foot, the second foot, and the fourth foot are the same, and a length of the third foot is shorter than the fourth foot.

The present application is based on, and claims priority from JP Application Serial Number 2023-150908, filed Sep. 19, 2023, the disclosure of which is hereby incorporated by reference herein in its entirety.

### BACKGROUND

### 1. Technical Field

The present disclosure relates to a medium processing device.

### 2. Related Art

For example, as described in JP 2009-192579 A, there is an image forming apparatus being an example of a medium processing device. The image forming apparatus includes four feet provided at a bottom plate. Each foot includes an adjustment mechanism capable of adjusting height.

The image forming apparatus may deform in accordance with distortion of a floor surface which is an example of an installation surface. This deformation is also referred to as a twist. When the image forming apparatus deforms, a positional shift may occur in a sheet which is an example of a medium, or distortion may occur in an image formed on the sheet. Therefore, an installer suppresses the distortion of the image forming apparatus by adjusting heights of the feet in accordance with the distortion of the floor surface.

In the image forming apparatus disclosed in JP 2009-192579 A, since the installer individually adjusts the height of the foot using a tool such as a spanner, workability is poor.

### SUMMARY

A medium processing device for solving the above-described problems is a medium processing device including a housing, a plurality of feet provided at a bottom portion of the housing, and configured to come into contact with an installation surface, and a medium processing unit provided inside the housing, and configured to perform processing on a medium, wherein the plurality of feet include a first foot, a second foot aligned with the first foot in a width direction of the medium processing device, a third foot aligned with the first foot in a depth direction of the medium processing device, and a fourth foot aligned with the second foot in the depth direction, and when, as regions defined by a first straight line passing through a center position of the medium processing device in the width direction and a second straight line passing through a center position of the medium processing device in the depth direction, a region where the first foot is located is a first region, a region where the second foot is located is a second region, a region where the third foot is located is a third region, and a region where the fourth foot is located is a fourth region, and as regions defined by a third straight line passing through the first foot and the fourth foot and a fourth straight line passing through the second foot and the third foot, a region adjacent to the first foot and the second foot is a fifth region, a region adjacent to the first foot and the third foot is a sixth region, a region adjacent to the second foot and the fourth foot is a seventh region, and a region adjacent to the third foot and the fourth foot is an eighth region, in a case where a center of gravity of the medium processing device is located in the fifth region, and the medium processing unit is provided across the second region and the fourth region, the first foot, the second foot, and the fourth foot have the same length, and a length of the third foot is shorter than the fourth foot.

### BRIEF DESCRIPTION OF THE DRAWINGS

FIG. 1 is a schematic view of an embodiment of a medium processing device.

FIG. 2 is a schematic view of a recording unit.

FIG. 3 is a schematic plan view of the medium processing device.

FIG. 4 is a schematic plan view of a first modification of the medium processing device.

FIG. 5 is a schematic plan view of a second modification of the medium processing device.

FIG. 6 is a schematic plan view of a third modification of the medium processing device.

FIG. 7 is a schematic plan view of a fourth modification of the medium processing device.

FIG. 8 is a schematic plan view of a fifth modification of the medium processing device.

FIG. 9 is a schematic plan view of a sixth modification of the medium processing device.

FIG. 10 is a schematic plan view of a seventh modification of the medium processing device.

### DESCRIPTION OF EMBODIMENTS

### Embodiment

An embodiment of a medium processing device will be described below with reference to the drawings. The medium processing device of the present embodiment is, for example, an ink-jet type printer that ejects ink, which is an example of liquid, onto a medium such as a sheet for recording.

In the drawings, a Z-axis represents a direction of gravity and an X-axis and a Y-axis represent directions along a horizontal plane, assuming that a medium processing device 11 is placed on the horizontal plane. The X-axis, the Y-axis, and the Z-axis are perpendicular to one another. In the following description, a direction parallel to the X-axis is also called a width direction X, a direction parallel to the Y-axis is also called a depth direction Y, and a direction parallel to the Z-axis is also called a vertical direction Z.

### Medium Processing Device

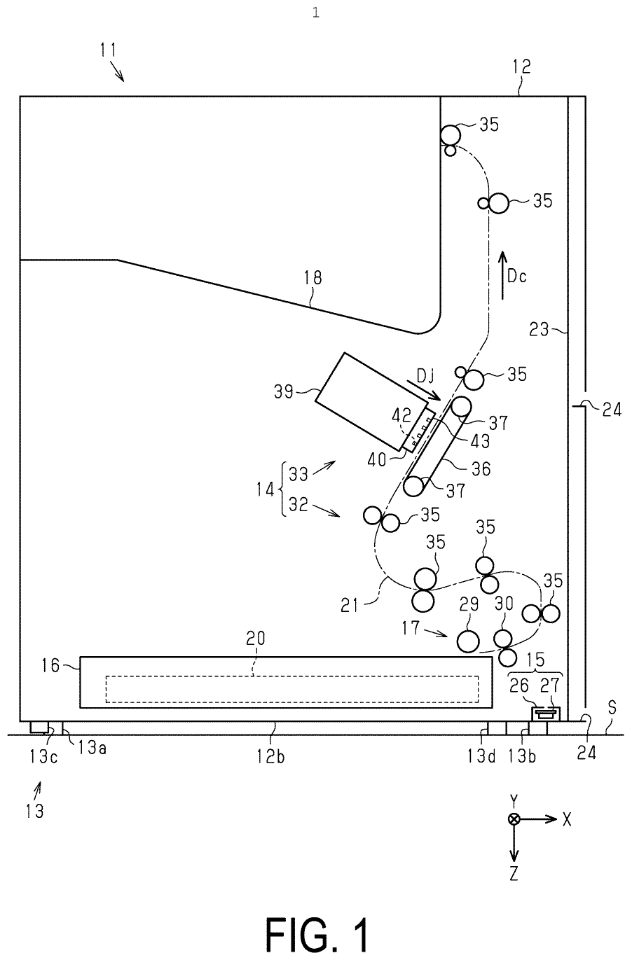

As illustrated in FIG. 1, the medium processing device 11 includes a housing 12, a plurality of feet 13, and a medium processing unit 14. The medium processing device 11 may include a detection unit 15, a cassette 16, a feeding unit 17, and a stacker 18. In FIG. 1, a transport path 21 in which a medium 20 is transported is indicated with a one-dot chain line. The transport path 21 is a path that couples the cassette 16 to the stacker 18.

The housing 12 accommodates various configurations of the medium processing device 11. The housing 12 may be covered with an exterior (not illustrated). The housing 12 may include at least one column 23. The column 23 may be a prismatic column or a circular column. The column 23 of the present embodiment has a hollow pipe structure. Inside the column 23, a harness may be passed through, or a component may be attached.

A hole 24 may be opened at a side surface of the column 23. A plurality of the holes 24 may be provided at one column 23. The hole 24 may be provided under a component (not illustrated) attached to the column 23. The hole 24 may be provided at a lower end of the column 23. The hole 24 may be formed by bending a part of the side surface of the column 23 inward the column 23. By providing the hole 24, for example, even when a component is dropped into the column 23, the dropped component can be easily collected.

The plurality of feet 13 are provided at a bottom portion 12b of the housing 12. The plurality of feet 13 can come into contact with an installation surface S. The plurality of feet 13 are located between the installation surface S and the housing 12, and support the housing 12. The plurality of feet 13 float the housing 12 with respect to the installation surface S. The plurality of feet 13 include a first foot 13a, a second foot 13b, a third foot 13c, and a fourth foot 13d.

The detection unit 15 is a capacitance sensor capable of detecting temperature and humidity. In the medium processing device 11, a detection result by the detection unit 15 may be used for transporting the medium 20. The detection unit 15 may include a holder 26 and a detection element 27. The detection unit 15 may be provided in the transport path 21 or may be provided in a vicinity of the transport path 21. The detection unit 15 provided near the transport path 21 can detect an environment in which the medium 20 is transported.

The holder 26 may have a box shape that covers the detection element 27 from above. The holder 26 may have a slit through which air passes. The detection unit 15 may be provided such that the detection element 27 faces downward. Since foreign matter such as paper dust adhering to the detection element 27 can be reduced by installing the detection element 27 facing downward, it is possible to suppress a decrease in detection accuracy due to the adhesion of the foreign matter.

The medium 20 can be accommodated in the cassette 16. The cassette 16 can be inserted into the housing 12 and drawn out from the housing 12 from a front surface side of the medium processing device 11. The cassette 16 may be able to accommodate a plurality of the media 20 in a stacked state.

The feeding unit 17 feeds, one by one to the transport path 21, the media 20 accommodated in the cassette 16. The feeding unit 17 may include a feeding roller 29 and a separation unit 30. The feeding roller 29 feeds the medium 20 to the transport path 21 by rotating in a state of being in contact with the medium 20. The feeding roller 29 feeds the medium 20 located uppermost among the media 20 accommodated in the cassette 16. The separation unit 30 separates the media 20 fed in an overlapped state one by one. The separation unit 30 presses and holds the second and subsequent media 20 from the top in the cassette 16.

### Medium Processing Unit

The medium processing unit 14 is provided inside the housing 12. The medium processing unit 14 performs processing on the medium 20. The medium processing unit 14 may include a transport unit 32 and a recording unit 33. The transport unit 32 performs transport processing of transporting the medium 20. The recording unit 33 performs recording processing of recording on the medium 20.

The transport unit 32 transports the medium 20 fed by the feeding unit 17 along the transport path 21. The transport unit 32 transports the medium 20 in a transport direction Dc. The transport direction Dc is a direction along the transport path 21. The transport direction Dc is a direction from the cassette 16 toward the stacker 18. The transport unit 32 may include one or more transport rollers 35, an endless transporting belt 36, and a pair of pulleys 37.

The transport roller 35 transports the medium 20 along the transport path 21 by rotating in a state of sandwiching the medium 20. The transport roller 35 discharges the recorded medium 20 to the stacker 18. The stacker 18 receives the medium 20 transported by the transport unit 32.

The transporting belt 36 is stretched around the pair of pulleys 37. The transporting belt 36 faces the recording unit 33 with the transport path 21 interposed therebetween. The transporting belt 36 supports a part of the medium 20 in a flat state. The transporting belt 36 may transport the medium 20 by rotating with the medium 20 attracted.

The recording unit 33 may include a holding unit 39 and a liquid ejecting unit 40. The holding unit 39 holds the liquid ejecting unit 40. The liquid ejecting unit 40 performs recording by ejecting liquid. The liquid ejecting unit 40 includes a nozzle surface 43 at which a plurality of nozzles 42 are opened. The liquid ejecting unit 40 may be provided such that the nozzle surface 43 is inclined with respect to the horizontal plane. The liquid ejecting unit 40 ejects the liquid in an ejection direction Dj. The ejection direction Dj may be a direction that is perpendicular to the nozzle surface 43 and intersects the vertical direction Z.

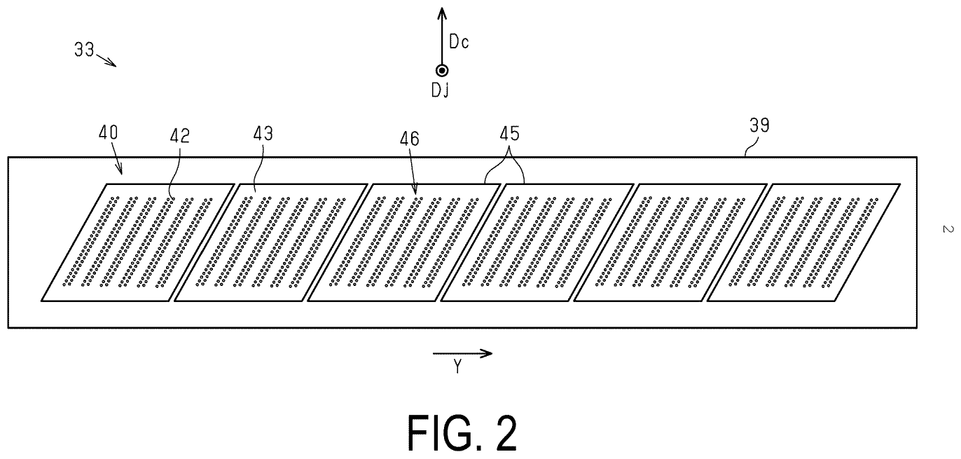

As illustrated in FIG. 2, the liquid ejecting unit 40 of the present embodiment is a line head provided along the depth direction Y. The liquid ejecting unit 40 ejects the liquid from the plurality of nozzles 42 toward the medium 20 being transported. The liquid ejecting unit 40 of the present embodiment performs recording by ejecting the liquid onto the medium 20 being transported in a stopped state. The liquid ejecting unit 40 performs recording in the depth direction Y by ejecting the liquid onto the medium 20 supported by the transporting belt 36.

The liquid ejecting unit 40 may include a plurality of unit heads 45. The plurality of unit heads 45 are aligned in the depth direction Y. The plurality of unit heads 45 have the same configuration. The unit head 45 includes a plurality of nozzle rows 46. That is, the liquid ejecting unit 40 includes a plurality of the nozzle rows 46. The nozzle row 46 is configured such that a plurality of the nozzles 42 are aligned. The plurality of nozzles 42 constituting one nozzle row 46 are aligned in a direction oblique to the transport direction Dc and the depth direction Y. The plurality of nozzle rows 46 are inclined at a predetermined angle with respect to the transport direction Dc in which the medium 20 is transported. The predetermined angle is, for example, an angle smaller than 90 degrees.

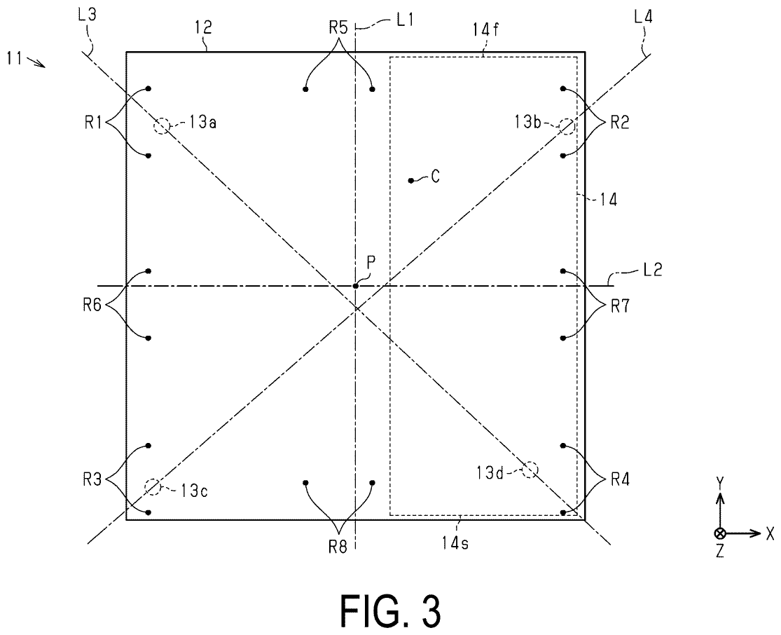

As illustrated in FIG. 3, a first end portion 14f and a second end portion 14s of the medium processing unit 14 may be fixed to the housing 12. The first end portion 14f is an end on a back surface side, and an end on the second foot 13b side. The second end portion 14s is an end on the front surface side, and an end on the fourth foot 13d side. The medium processing unit 14 may be directly fixed to the housing 12. The medium processing unit 14 may be indirectly fixed to the housing 12 via a fixing member or the like. In the recording unit 33, both ends of the holding unit 39 may be fixed to the housing 12. In the transport unit 32, bearings of the transport roller 35 and the pulley 37 may be fixed to the housing 12.

### Foot

As illustrated in FIG. 3, the housing 12 may have a substantially square shape in plan view. The first foot 13a to the fourth foot 13d may be provided at four corners of the medium processing device 11.

The first foot 13a and the second foot 13b are provided on the back surface side of the medium processing device 11. The second foot 13b is aligned with the first foot 13a in the width direction X of the medium processing device 11. The third foot 13c and the fourth foot 13d are provided on the front surface side of the medium processing device 11. The third foot 13c is aligned with the first foot 13a in the depth direction Y of the medium processing device 11. The fourth foot 13d is aligned with the second foot 13b in the depth direction Y.

As illustrated in FIG. 1, the first foot 13a, the second foot 13b, and the fourth foot 13d have the same length. To be specific, in the first foot 13a, the second foot 13b, and the fourth foot 13d, lengths in the vertical direction Z from the bottom portion 12b to respective lower ends thereof are the same. For example, the first foot 13a, the second foot 13b, and the fourth foot 13d may have the same length by attaching the same members to the bottom portion 12b. That is, component tolerances and assembly errors may be omitted from the lengths of the first foot 13a, the second foot 13b, and the fourth foot 13d.

A length of the third foot 13c is shorter than the fourth foot 13d. A length from the bottom portion 12b to a lower end of the third foot 13c in the vertical direction Z is shorter than the length from the bottom portion 12b to the lower end of the fourth foot 13d in the vertical direction Z. The third foot 13c may be reduced in length by using a smaller component than each of the first foot 13a, the second foot 13b, and the fourth foot 13d. The third foot 13c may be attached at a position higher than the bottom portion 12b to shorten a distance from the bottom portion 12b to the lower end. In this case, the third foot 13c may be the same component as the first foot 13a, the second foot 13b, and the fourth foot 13d.

As illustrated in FIG. 3, in the present embodiment, a first straight line L1 to a fourth straight line L4 each indicated by one-dot chain line, and a first region R1 to an eighth region R8 are defined. In the present embodiment, a position of a center of the medium processing device 11 in the width direction X and the depth direction Y is defined as a center position P.

The first straight line L1 is a line passing through the center position P and extending in the depth direction Y. The second straight line L2 is a line passing through the center position P and extending in the width direction X. The third straight line L3 is a line passing through the first foot 13a and the fourth foot 13d. The fourth straight line L4 is a line passing through the second foot 13b and the third foot 13c.

The first region R1 is a region defined by the first straight line L1 and the second straight line L2, and is a region where the first foot 13a is located.

The second region R2 is a region defined by the first straight line L1 and the second straight line L2, and is a region where the second foot 13b is located.

The third region R3 is a region defined by the first straight line L1 and the second straight line L2, and is a region where the third foot 13c is located.

The fourth region R4 is a region defined by the first straight line L1 and the second straight line L2, and is a region where the fourth foot 13d is located.

The fifth region R5 is a region defined by the third straight line L3 and the fourth straight line L4, and is a region adjacent to the first foot 13a and the second foot 13b.

The sixth region R6 is a region defined by the third straight line L3 and the fourth straight line L4, and is a region adjacent to the first foot 13a and the third foot 13c.

The seventh region R7 is a region defined by the third straight line L3 and the fourth straight line L4, and is a region adjacent to the second foot 13b and the fourth foot 13d.

The eighth region R8 is a region defined by the third straight line L3 and the fourth straight line L4, and is a region adjacent to the third foot 13c and the fourth foot 13d.

The medium processing unit 14 of the present embodiment is provided across the second region R2 and the fourth region R4. The medium processing unit 14 is provided across the plurality of regions aligned in the depth direction Y.

In the medium processing device 11 of the present embodiment, a center of gravity C is located in the fifth region R5. The center of gravity C is located on the back surface side of the medium processing device 11. The center of gravity C may be located in the fifth region R5 at a position overlapping the first region R1 or may be located at a position overlapping the second region R2. The center of gravity C may be located on an opposite side to the third foot 13c in the depth direction Y with respect to the second straight line L2. The center of gravity C may be located in a region diagonal to the third foot 13c.

### Operation of Embodiment

Operation of the present embodiment will be described.

When the medium processing device 11 is installed on the installation surface S, the first foot 13a and the second foot 13b on the back surface side where the center of gravity C is located, and the fourth foot 13d having the same length as the first foot 13a and the second foot 13b come into contact with the installation surface S. The installation of the medium processing device 11 is regarded as completed in a state in which the third foot 13c floats from the installation surface S.

Since the third foot 13c is floating, a twist of the housing 12 is likely to occur in a direction in which the third foot 13c lowers. However, the medium processing unit 14 is located on an opposite side of the third foot 13c with respect to the first straight line L1. Therefore, even when a twist occurs in the housing 12 near the third foot 13c, influence on processing of the medium 20 by the medium processing unit 14 is limited.

### Effects of Embodiment

Effects of the present embodiment will be described.
(1-1) When distortion occurs in the installation surface S, such as a step being present on the installation surface S, the foot 13 in the region where the center of gravity C is located is necessarily in contact with the installation surface S, and the foot 13 in the region where the center of gravity C is not located is likely to float. When the floating foot 13 is displaced downward, there is a risk that the housing 12 and the medium processing unit 14 are twisted. In the present embodiment, the length of the third foot 13c is shorter than the length of each of the first foot 13a, the second foot 13b, and the fourth foot 13d. Therefore, by making the third foot 13c easily float from the installation surface S, it is possible to make the first foot 13a, the second foot 13b, and the fourth foot 13d easily come into contact with the installation surface S. Further, when the fourth foot 13d floats, a displacement amount of the fourth foot 13d can be suppressed. Specifically, the displacement amount of the fourth foot 13d can be suppressed by a difference between the length of the third foot 13c and the length of the fourth foot 13d. The first foot 13a, the second foot 13b, and the fourth foot 13d support the regions where the center of gravity C of the medium processing device 11 and the medium processing unit 14 are located. Therefore, it is possible to suppress a twist of the region where the medium processing unit 14 is provided, and it is possible to easily suppress influence of the twist on medium processing without adjusting a height of the foot 13 by the installer.
(1-2) The first end portion 14f and the second end portion 14s of the medium processing unit 14 are fixed to the housing 12. That is, since a location to which the first end portion 14f is fixed and a location to which the second end portion 14s is fixed are separated from each other, the housing 12 is easily deformed. However, the second foot 13b is provided at a location to which the first end portion 14f is fixed. The fourth foot 13d is provided at a location to which the second end portion 14s is fixed. Therefore, it is possible to suppress a twist of the region where the medium processing unit 14 is provided.
(1-3) For example, when a twist occurs in a region where the transport unit 32 is provided, there is a risk that the transport unit 32 is not be able to transport the medium 20 straight. In this regard, since a twist of a region where the medium processing unit 14 including the transport unit 32 is provided is suppressed, it is possible to suppress influence of a twist on the transport of the medium 20.
(1-4) For example, when a twist occurs in a region where the recording unit 33 is provided, there is a risk that recording quality is deteriorated, such as a distortion occurring in a recorded image. In this regard, since a twist of a region where the medium processing unit 14 including the recording unit 33 is provided is suppressed, it is possible to suppress influence of a twist on the recording quality.
(1-5) When a twist occurs in a region where the liquid ejecting unit 40 is provided, there is a risk that a position at which liquid adheres to the medium 20 is shifted or the like and the recording quality is deteriorated. In this regard, since a twist of a region where the medium processing unit 14 including the liquid ejecting unit 40 is provided is suppressed, it is possible to suppress influence of a twist on the recording quality.
(1-6) Since a length of the line head is larger than a length of the medium 20, influence when a twist occurs is likely to increase. In this regard, since a twist of a region where the line head is provided is suppressed, it is possible to suppress deterioration of the recording quality.
(1-7) The plurality of nozzle rows 46 are inclined with respect to the transport direction Dc, thus when a twist occurs, there is a risk that a place to which liquid does not adhere or a place to which the liquid adheres in an overlapping manner occurs. In this regard, since a twist of the region where the line head is provided is suppressed, it is possible to suppress deterioration of the recording quality.
(1-8) When a heavy component is located on the front surface side of the medium processing device 11, workability for a user may be deteriorated. In this regard, the center of gravity C of the medium processing device 11 is located on the back surface side. Therefore, a heavy component can be easily located on the back surface side of the medium processing device 11, and thus it is possible to suppress the deterioration in workability.

### Modifications

The present embodiment may be modified as follows for implementation. The present embodiment and modifications described below may be combined for implementation insofar as they are not technically inconsistent.

### First Modification

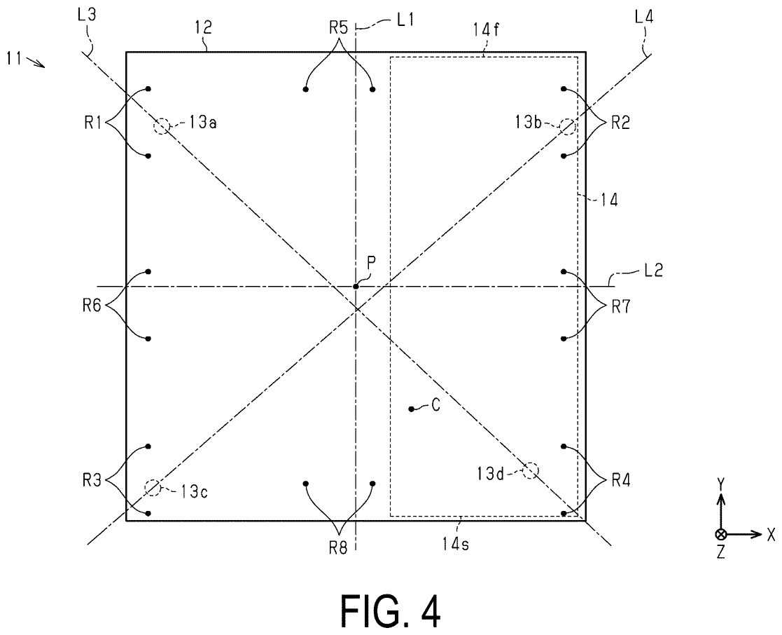

As illustrated in FIG. 4, the center of gravity C may be located in the eighth region R8. The center of gravity C may be located on the front surface side of the medium processing device 11. The center of gravity C may be located in a region where the eighth region R8 and the third region R3 overlap each other, or may be located in a region where the eighth region R8 and the fourth region R4 overlap each other. When the medium processing unit 14 is provided across the second region R2 and the fourth region R4, the length of the first foot 13a may be made shorter than the length of the second foot 13b. The second foot 13b, the third foot 13c, and the fourth foot 13d may have the same length.

### Second Modification

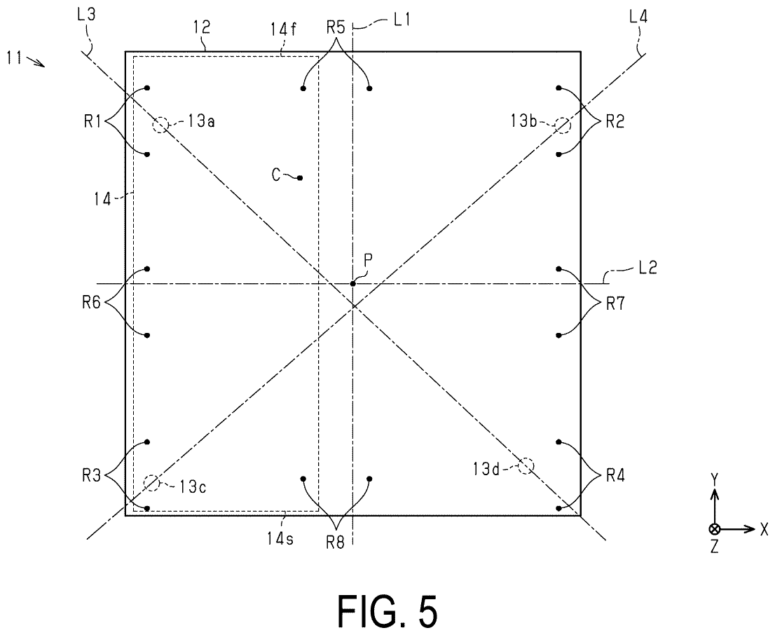

As illustrated in FIG. 5, the center of gravity C may be located in the fifth region R5. The center of gravity C may be located on the back surface side of the medium processing device 11. The center of gravity C may be located in a region where the fifth region R5 and the first region R1 overlap each other, or may be located in a region where the fifth region R5 and the second region R2 overlap each other. When the medium processing unit 14 is provided across the first region R1 and the third region R3, the length of the fourth foot 13d may be made shorter than the length of the third foot 13c. The first foot 13a, the second foot 13b, and the third foot 13c may have the same length.

### Third Modification

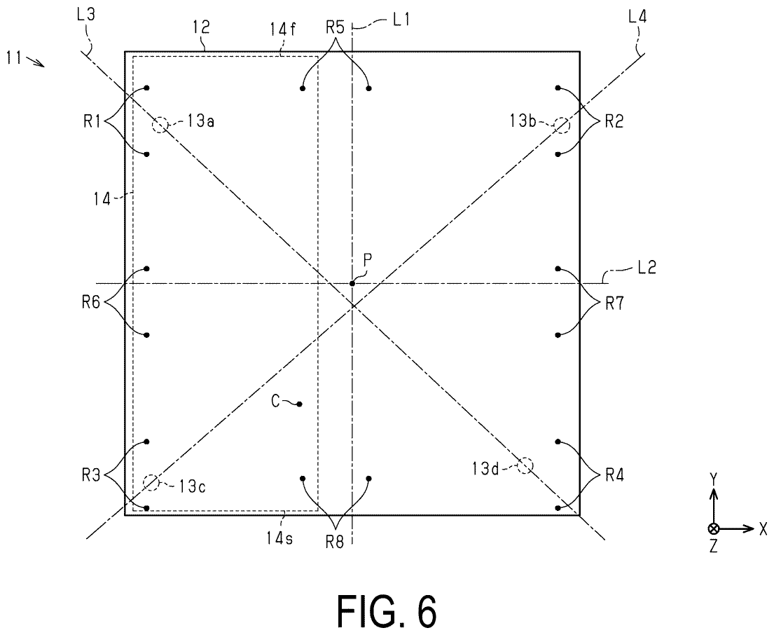

As illustrated in FIG. 6, the center of gravity C may be located in the eighth region R8. The center of gravity C may be located on the front surface side of the medium processing device 11. The center of gravity C may be located in the region where the eighth region R8 and the third region R3 overlap each other, or may be located in the region where the eighth region R8 and the fourth region R4 overlap each other. When the medium processing unit 14 is provided across the first region R1 and the third region R3, the length of the second foot 13b may be made shorter than the length of the first foot 13a. The first foot 13a, the third foot 13c, and the fourth foot 13d may have the same length.

### Fourth Modification

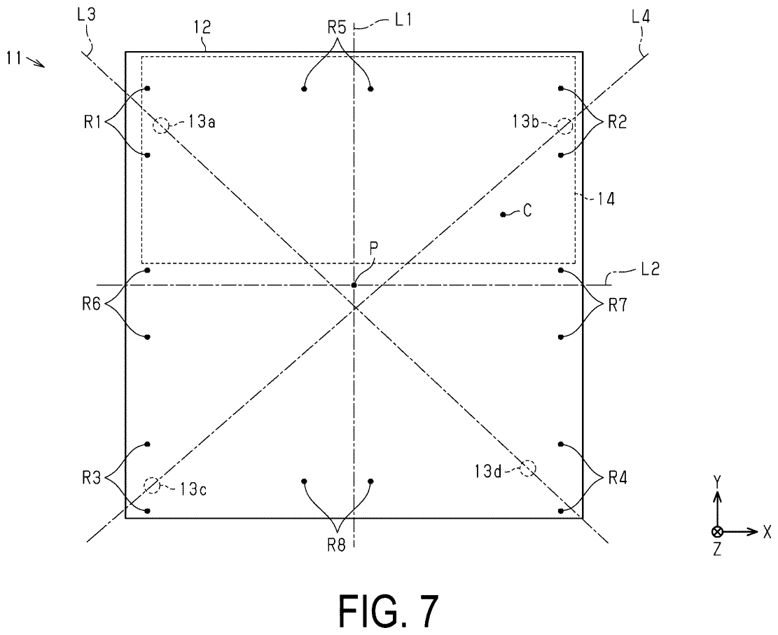

As illustrated in FIG. 7, the center of gravity C may be located in the seventh region R7. The center of gravity C may be located on a side surface side of the medium processing device 11. The center of gravity C may be located in a region where the seventh region R7 and the second region R2 overlap each other, or may be located in a region where the seventh region R7 and the fourth region R4 overlap each other. When the medium processing unit 14 is provided across the first region R1 and the second region R2, the length of the third foot 13c may be made shorter than the length of the fourth foot 13d. The first foot 13a, the second foot 13b, and the fourth foot 13d may have the same length. Both ends of the medium processing unit 14 in the width direction X may be fixed to the housing 12.

### Fifth Modification

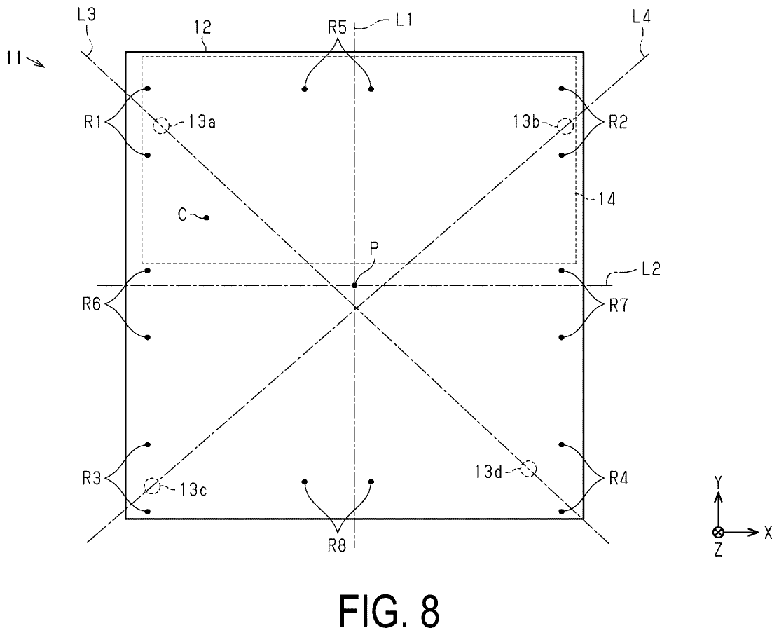

As illustrated in FIG. 8, the center of gravity C may be located in the sixth region R6. The center of gravity C may be located on a side surface side of the medium processing device 11. The center of gravity C may be located in a region where the sixth region R6 and the first region R1 overlap each other, or may be located in a region where the sixth region R6 and the third region R3 overlap each other. When the medium processing unit 14 is provided across the first region R1 and the second region R2, the length of the fourth foot 13d may be made shorter than the length of the third foot 13c. The first foot 13a, the second foot 13b, and the third foot 13c may have the same length.

### Sixth Modification

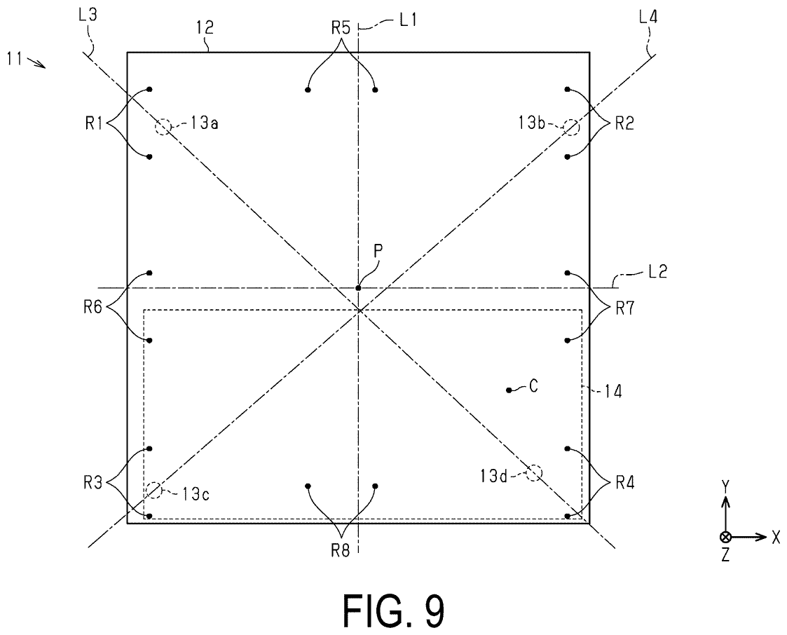

As illustrated in FIG. 9, the center of gravity C may be located in the seventh region R7. The center of gravity C may be located on the side surface side of the medium processing device 11. The center of gravity C may be located in the region where the seventh region R7 and the second region R2 overlap each other, or may be located in the region where the seventh region R7 and the fourth region R4 overlap each other. When the medium processing unit 14 is provided across the third region R3 and the fourth region R4, the length of the first foot 13a may be made shorter than the length of the second foot 13b. The second foot 13b, the third foot 13c, and the fourth foot 13d may have the same length.

### Seventh Modification

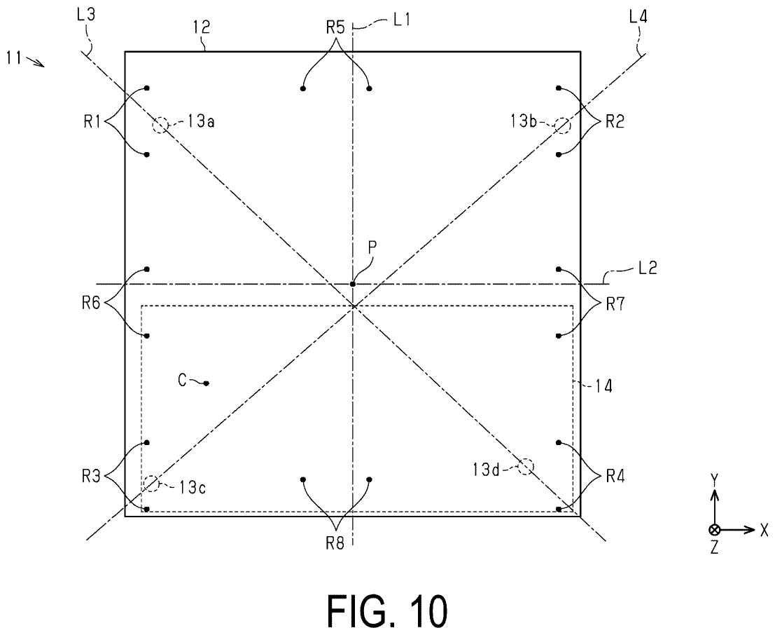

As illustrated in FIG. 10, the center of gravity C may be located in the sixth region R6. The center of gravity C may be located on the side surface side of the medium processing device 11. The center of gravity C may be located in the region where the sixth region R6 and the first region R1 overlap each other, or may be located in the region where the sixth region R6 and the third region R3 overlap each other. When the medium processing unit 14 is provided across the third region R3 and the fourth region R4, the length of the second foot 13b may be made shorter than the length of the first foot 13a. The first foot 13a, the third foot 13c, and the fourth foot 13d may have the same length.

### Other Modifications

The medium processing unit 14 may be located on one side in the width direction X with respect to the first straight line L1, and the center of gravity C may be located on another side in the width direction X with respect to the first straight line L1. For example, the medium processing unit 14 may be provided across the second region R2 and the fourth region R4, and the center of gravity C may be located in the sixth region R6. In this case, one of the second foot 13b and the fourth foot 13d may be shorter than another. Of the second foot 13b and the fourth foot 13d, the foot at which rigidity of the housing 12 is higher may be shorter.
The medium processing unit 14 may be located on one side in the depth direction Y with respect to the second straight line L2, and the center of gravity C may be located on another side in the depth direction Y with respect to the second straight line L2. For example, the medium processing unit 14 may be provided across the first region R1 and the second region R2, and the center of gravity C may be located in the eighth region R8. In this case, one of the first foot 13a and the second foot 13b may be shorter than another. Of the first foot 13a and the second foot 13b, the foot at which the rigidity of the housing 12 is higher may be shorter.
The nozzle row 46 may extend in the depth direction Y.
The nozzle row 46 may extend in the transport direction Dc. The liquid ejecting unit 40 may be a serial head that can reciprocate in the depth direction Y.
The medium processing device 11 may be a supply device that supplies the medium 20 to, for example, a printer. The medium processing unit 14 may include the transport unit 32 that transports the medium 20, and need not include the recording unit 33.
The medium processing device 11 may be a post-processing device that performs post-processing on the recorded medium 20. The medium processing unit 14 may include a post-processing unit. The medium processing unit 14 may perform stapler processing of stapling a plurality of the media 20 with a staple, punching processing of punching a hole in the medium 20, shifting processing of shifting the media 20 for collation per unit and discharging the media 20, or the like.
The medium processing unit 14 may include a reading unit that performs reading processing of reading an image of the medium 20.
In the above-described embodiment, one of the first end portion 14f and the second end portion 14s of the medium processing unit 14 may be fixed to the housing 12. An end portion of the medium processing unit 14 on the width direction X side may be fixed to the housing 12.
The medium processing device 11 may include five or more feet 13.
The medium processing device 11 is not limited to the ink jet-type printer, and may be a laser printer, a thermal printer, a dot impact printer, a digital printing machine, or the like.

### Definition

A representation “at least one” as used herein means “one or more” of desired options. As an example, the representation “at least one” as used herein means “only one option” or “both of two options” when the number of options is two. As another example, the representation “at least one” as used herein means “only one option”, “any combination of two options”, or “any combination of three or more options” when the number of options is three or more.

### APPENDIX

The following is a description of the technical ideas and their effects that can be grasped from the above-described embodiment and modifications.
(A) A medium processing device is a medium processing device including a housing, a plurality of feet provided at a bottom portion of the housing, and configured to come into contact with an installation surface, and a medium processing unit provided inside the housing, and configured to perform processing on a medium, wherein the plurality of feet include a first foot, a second foot aligned with the first foot in a width direction of the medium processing device, a third foot aligned with the first foot in a depth direction of the medium processing device, and a fourth foot aligned with the second foot in the depth direction, and when, as regions defined by a first straight line passing through a center position of the medium processing device in the width direction and a second straight line passing through a center position of the medium processing device in the depth direction, a region where the first foot is located is a first region, a region where the second foot is located is a second region, a region where the third foot is located is a third region, and a region where the fourth foot is located is a fourth region, and as regions defined by a third straight line passing through the first foot and the fourth foot and a fourth straight line passing through the second foot and the third foot, a region adjacent to the first foot and the second foot is a fifth region, a region adjacent to the first foot and the third foot is a sixth region, a region adjacent to the second foot and the fourth foot is a seventh region, and a region adjacent to the third foot and the fourth foot is an eighth region, in a case where a center of gravity of the medium processing device is located in the fifth region, and the medium processing unit is provided across the second region and the fourth region, the first foot, the second foot, and the fourth foot have the same length, and a length of the third foot is shorter than the fourth foot.

According to this configuration, the length of the third foot is shorter than the length of each of the first foot, the second foot, and the fourth foot. Therefore, by making the third foot easily float from the installation surface, it is possible to easily bring the first foot, the second foot, and the fourth foot into contact with the installation surface. In addition, even when the fourth foot floats, a displacement amount of the fourth foot can be suppressed. The first foot, the second foot, and the fourth foot support regions where the center of gravity of the medium processing device and the medium processing unit are located. Therefore, it is possible to suppress a twist of the region where the medium processing unit is provided, and it is possible to easily suppress influence of a twist on medium processing.
(B) In the medium processing device according to (A), a first end portion on the second foot side and a second end portion on the fourth foot side of the medium processing unit may be fixed to the housing. According to this configuration, the first end portion and the second end portion of the medium processing unit are fixed to the housing. That is, since a location to which the first end portion is fixed and a location to which the second end portion is fixed are separated from each other, the housing is easily deformed. However, the second foot is provided at the location to which the first end portion is fixed. The fourth foot is provided at the location to which the second end portion is fixed. Therefore, it is possible to suppress a twist of the region where the medium processing unit provided.
(C) In the medium processing device according to (A) or (B), the medium processing unit may include a transport unit that transports the medium.

For example, when a twist occurs in a region where the transport unit is provided, there is a risk that the transport unit is not be able to transport the medium straight. In this regard, according to this configuration, since a twist of a region where the medium processing unit including the transport unit is provided is suppressed, it is possible to suppress influence of a twist on the transport of the medium.
(D) In the medium processing device according to (A) to (C), the medium processing unit may include a recording unit that performs recording on the medium.

For example, when a twist occurs in a region where the recording unit is provided, there is a risk that recording quality is deteriorated, such as a distortion occurring in a recorded image. In this regard, according to this configuration, since a twist of a region where the medium processing unit including the recording unit is provided is suppressed, it is possible to suppress influence of a twist on the recording quality.
(E) In the medium processing device according to (D), the recording unit may include a liquid ejecting unit that performs recording by ejecting liquid.

When a twist occurs in a region where the liquid ejecting unit is provided, there is a risk that a position at which liquid adheres to the medium is shifted or the like and the recording quality is deteriorated. In this regard, according to this configuration, since a twist of a region where the medium processing unit including the liquid ejecting unit is provided is suppressed, it is possible to suppress influence of a twist on the recording quality.
(F) In the medium processing device according to (E), the liquid ejecting unit may be a line head provided along the depth direction.

Since a length of the line head is larger than a length of the medium, influence when a twist occurs is likely to increase. In this regard, according to this configuration, since a twist of a region where the line head is provided is suppressed, it is possible to suppress deterioration of the recording quality.
(G) In the medium processing device according to (E) or (F), the liquid ejecting unit may include a plurality of nozzle rows, and the plurality of nozzle rows may be inclined at a predetermined angle with respect to a transport direction in which the medium is transported.

Since the plurality of nozzle rows are inclined with respect to the transport direction, there is a risk that a place to which liquid does not adhere or a place to which the liquid adheres in an overlapping manner may occur, when a twist occurs. In this regard, according to this configuration, since a twist of the region where the line head is provided is suppressed, it is possible to suppress deterioration of the recording quality.
(H) In the medium processing device according to (A) to (G), the center of gravity may be located on a back surface side of the medium processing device, the third foot and the fourth foot may be provided on a front surface side of the medium processing device, and the first foot and the second foot may be provided on the back surface side of the medium processing device.

When a heavy component is located on the front surface side of the medium processing device, workability for a user may be deteriorated. In this regard, according to this configuration, the center of gravity of the medium processing device is located on the back surface side. Therefore, a heavy component can be easily located on the back surface side of the medium processing device, and thus it is possible to suppress the deterioration in workability.

What is claimed is:

1. A medium processing device, comprising:
a housing;
a plurality of feet provided at a bottom portion of the housing, and configured to come into contact with an installation surface; and
a medium processing unit provided inside the housing, and configured to perform processing on a medium, wherein
the plurality of feet include
a first foot,
a second foot aligned with the first foot in a width direction of the medium processing device,
a third foot aligned with the first foot in a depth direction of the medium processing device, and
a fourth foot aligned with the second foot in the depth direction, and
when,
as regions defined by a first straight line passing through a center position of the medium processing device in the width direction and a second straight line passing through a center position of the medium processing device in the depth direction, a region where the first foot is located is a first region, a region where the second foot is located is a second region, a region where the third foot is located is a third region, and a region where the fourth foot is located is a fourth region, and
as regions defined by a third straight line passing through the first foot and the fourth foot and a fourth straight line passing through the second foot and the third foot, a region adjacent to the first foot and the second foot is a fifth region, a region adjacent to the first foot and the third foot is a sixth region, a region adjacent to the second foot and the fourth foot is a seventh region, and a region adjacent to the third foot and the fourth foot is an eighth region,
in a case where a center of gravity of the medium processing device is located in the fifth region, and the medium processing unit is provided across the second region and the fourth region, the first foot, the second foot, and the fourth foot have the same length, and a length of the third foot is shorter than the fourth foot.

2. The medium processing device according to claim 1, wherein
a first end portion on the second foot side and a second end portion on the fourth foot side of the medium processing unit are fixed to the housing.

3. The medium processing device according to claim 1, wherein
the medium processing unit includes a transport unit that transports the medium.

4. The medium processing device according to claim 3, wherein
the medium processing unit includes a recording unit that performs recording on the medium.

5. The medium processing device according to claim 4, wherein
the recording unit includes a liquid ejecting unit that performs recording by ejecting liquid.

6. The medium processing device according to claim 5, wherein
the liquid ejecting unit is a line head provided along the depth direction.

7. The medium processing device according to claim 6, wherein
the liquid ejecting unit includes a plurality of nozzle rows, and
the plurality of nozzle rows are inclined at a predetermined angle with respect to a transport direction in which the medium is transported.

8. The medium processing device according to claim 5, wherein
the center of gravity is located on a back surface side of the medium processing device,
the third foot and the fourth foot are provided on a front surface side of the medium processing device, and
the first foot and the second foot are provided on the back surface side of the medium processing device.

9. A medium processing device, comprising:
a housing;
a plurality of feet provided at a bottom portion of the housing, and configured to come into contact with an installation surface; and
a medium processing unit provided inside the housing, and configured to perform processing on a medium, wherein
the plurality of feet include
a first foot,
a second foot aligned with the first foot in a width direction of the medium processing device,
a third foot aligned with the first foot in a depth direction of the medium processing device, and
a fourth foot aligned with the second foot in the depth direction, and
when,
as regions defined by a first straight line passing through a center position of the medium processing device in the width direction and a second straight line passing through a center position of the medium processing device in the depth direction, a region where the first foot is located is a first region, a region where the second foot is located is a second region, a region where the third foot is located is a third region, and a region where the fourth foot is located is a fourth region, and
as regions defined by a third straight line passing through the first foot and the fourth foot and a fourth straight line passing through the second foot and the third foot, a region adjacent to the first foot and the second foot is a fifth region, a region adjacent to the first foot and the third foot is a sixth region, a region adjacent to the second foot and the fourth foot is a seventh region, and a region adjacent to the third foot and the fourth foot is an eighth region,
in a case where a center of gravity of the medium processing device is located in the fifth region, and the medium processing unit is provided across the second region and the fourth region, a length of the third foot is shorter than the fourth foot, and the difference between the length of the third foot and the length of the fourth foot is greater than the difference between a length of the first foot and the length of the fourth foot.
